(19) United States
(12) Patent Application Publication
(10) Pub. No.: US 2024/0339749 A1
(43) Pub. Date: Oct. 10, 2024

(54) ANTENNA SYSTEM AND COMMUNICATION DEVICE

(71) Applicant: HUAWEI TECHNOLOGIES CO., LTD., Shenzhen (CN)

(72) Inventors: He Cui, Dongguan (CN); Weihong Xiao, Dongguan (CN); Jianping Li, Dongguan (CN); Biao Pu, Dongguan (CN)

(73) Assignee: HUAWEI TECHNOLOGIES CO., LTD., Shenzhen (CN)

(21) Appl. No.: 18/745,860

(22) Filed: Jun. 17, 2024

Related U.S. Application Data
(63) Continuation of application No. PCT/CN2022/138412, filed on Dec. 12, 2022.

(30) Foreign Application Priority Data
Dec. 16, 2021 (CN) 202111540850.7

(51) Int. Cl. H01Q 1/24; H01Q 1/42; H01Q 15/00; H01Q 21/28

(52) U.S. Cl. CPC H01Q 1/246; H01Q 1/42; H01Q 15/0013; H01Q 21/28

(57) ABSTRACT

This disclosure provides an antenna system. The antenna system includes a first antenna and a second antenna. The first antenna includes a first radome, a first radiating assembly, and a feed network. The second antenna includes a second radome and a second radiating assembly. The first radome has a first outer surface. The first outer surface has a groove. The feed network is disposed on a side part of the groove, and the feed network is disposed in the first radome and is connected to the first radiating assembly. The second radome has a second outer surface, the second radiating assembly is disposed in the second radome, and at least a part of the second outer surface extends into the groove. In the antenna system provided in this disclosure, when the first antenna and the second antenna are used in combination, a thickness size is not significantly increased.

### CROSS-REFERENCE TO RELATED APPLICATIONS

This application is a continuation of International Patent Application No. PCT/CN2022/138412, filed on Dec. 12, 2022, which claims priority to Chinese Patent Application No. 202111540850.7, filed on Dec. 16, 2021. The disclosures of the aforementioned applications are hereby incorporated by reference in their entireties.

### TECHNICAL FIELD

This disclosure relates to the field of communication technologies, and in particular, to an antenna system and a communication device.

### BACKGROUND

With development of wireless communication technologies, a base station can support more communication frequency bands, and more antennas are mounted on a pole. Because a position for mounting an antenna on a pole is limited, some poles cannot accommodate more antennas. Therefore, effective integration of different antennas gradually becomes a current trend. However, in a current integration manner, a frontal area of an antenna is significantly increased. In this way, the current integration manner needs to be optimized.

### SUMMARY

This disclosure provides an antenna system and a communication device that can effectively reduce a frontal area and facilitate flexible combination therefor.

In an aspect, this disclosure provides an antenna system. The antenna system includes a first antenna and a second antenna. The first antenna includes a first radome, a first radiating assembly, and a feed network. The second antenna includes a second radome and a second radiating assembly. The first radome has a first outer surface, and the first outer surface has a groove. The first radiating assembly is disposed in the first radome, and is configured to emit or receive an electromagnetic wave. The feed network is connected to the first radiating assembly, so that the feed network feeds a signal to the first radiating assembly based on a specific amplitude and phase. In addition, the feed network is disposed in the first radome, and is located at a side part of the groove. In addition, the second radome has a second outer surface, the second radiating assembly is disposed in the second radome, and at least a part of the second outer surface may extend into the groove.

In the antenna system provided in this disclosure, the first antenna and the second antenna are two mutually independent antennas. The two antennas may be used independently, or the two antennas may be used in combination. When the two antennas are used in combination, a thickness size is not significantly increased. Therefore, this helps reduce a frontal area, and improve use security. Specifically, because the first radome has the groove, and the second outer surface of the second radome may extend into the groove, after the first antenna and the second antenna are combined, an overall thickness is less than a sum of thicknesses of the first antenna and the second antenna. Therefore, this helps reduce a thickness size of the entire antenna system. In addition, because the feed network is disposed on the side part of the groove, an electromagnetic wave generated by the feed network does not significantly affect normal operation of the second radiating assembly in the second antenna. Therefore, this helps ensure normal operating performance of the second antenna.

In an implementation, the first antenna may further include a first frequency selective surface. The first frequency selective surface is located between the first radiating assembly and the second radiating assembly, and is configured to reflect a signal of the first radiating assembly and transmit a signal of the second radiating assembly. An electromagnetic wave generated by the first radiating assembly can be propagated in a direction away from the first frequency selective surface based on the first frequency selective surface. In addition, when a part of the electromagnetic wave is propagated to the first frequency selective surface, the part of the electromagnetic wave can be reflected by the first frequency selective surface, so that propagation efficiency of the first radiating assembly can be effectively improved. In addition, an electromagnetic wave generated by the second radiating assembly can be effectively propagated through the first frequency selective surface, so that normal operating performance of the second radiating assembly is not affected.

During specific disposition, a projection of the first radiating assembly on the first frequency selective surface may be completely located in the first frequency selective surface, so that the first frequency selective surface can well reflect the electromagnetic wave generated by the first radiating assembly.

In an implementation, a projection of the feed network on the second radiating assembly may be located outside the second radiating assembly, so that a case in which the feed network causes adverse impact such as obstructing on the electromagnetic wave generated by the second radiating assembly can be effectively avoided.

In an implementation, the first antenna may further include a third radiating assembly, and an operating frequency band of the third radiating assembly may be different from an operating frequency band of the first radiating assembly, to improve an operating frequency band range of the first antenna.

During specific disposition, the third radiating assembly and the first radiating assembly may be located on a same side of the first frequency selective surface. In other words, the first frequency selective surface can reflect the signal of the first radiating assembly and a signal of the third radiating assembly, so that the electromagnetic wave of the first radiating assembly and an electromagnetic wave of the third radiating assembly can be efficiently propagated in the direction away from the first frequency selective surface.

In an implementation, the first antenna may further include a second frequency selective surface. The third radiating assembly and the first radiating assembly are located on a same side of the second frequency selective surface. The second frequency selective surface is configured to reflect the signal of the first radiating assembly and the signal of the third radiating assembly and transmit the signal of the second radiating assembly.

During specific disposition, types of the first frequency selective surface and the second frequency selective surface may be the same or different. This is not limited in this disclosure.

In addition, a projection of the third radiating assembly on the second frequency selective surface may be located in the second frequency selective surface, so that the electromagnetic wave generated by the third radiating assembly can be well reflected.

When the third radiating assembly is specifically disposed, a projection of the third radiating assembly on a bottom wall of the groove may be located in the bottom wall. Certainly, in another implementation, a projection of the third radiating assembly on a bottom wall of the groove may alternatively be located outside the bottom wall. This is not limited in this disclosure.

In addition, the operating frequency band of the first radiating assembly and the operating frequency band of the third radiating assembly may be less than an operating frequency band of the second radiating assembly. The operating frequency band of the first radiating assembly may be greater than the operating frequency band of the third radiating assembly, or the operating frequency band of the first radiating assembly may be less than the operating frequency band of the third radiating assembly. During specific application, the operating frequency bands of the first radiating assembly, the second radiating assembly, and the third radiating assembly may be properly selected based on actual requirements. This is not specifically limited in this disclosure.

In addition, in terms of structure arrangement of the first radome and the second radome, the second outer surface of the second radome may alternatively completely extend into the groove.

Alternatively, when an area of the second outer surface is greater than an area of the bottom wall of the groove, the second outer surface may have a protruding part, and the protruding part may extend into the groove.

A projection of the second radiating assembly on the second outer surface may be located in the protruding part, to avoid a case in which the feed network located at the side part of the groove causes adverse impact such as obstructing on the second radiating assembly.

In addition, the first radome and the second radome may be connected in a detachable manner, to facilitate combination and separation between the first antenna and the second antenna.

In another aspect, this disclosure further provides a communication device. The communication device includes any antenna system described above. The communication device may be a base station, radar, or the like. A specific type of the communication device is not limited in this disclosure. The foregoing antenna system is configured, so that a quantity of antenna systems configured in a base station can be effectively increased, and a frontal area of the communication device is not significantly increased. This is conducive to deployment and use of the antenna system in a large range.

### BRIEF DESCRIPTION OF DRAWINGS

FIG. 1 is a diagram of an application scenario of an antenna system according to an embodiment of this application;

FIG. 2 is a diagram of a structure of a base station antenna feeder system according to an embodiment of this disclosure;

FIG. 3 is a diagram of composition of an antenna system according to an embodiment of this disclosure;

FIG. 4 is a diagram of a structure in which an antenna system is separated according to an embodiment of this disclosure;

FIG. 5 is a diagram of a cross-sectional structure in an A-A direction in FIG. 4;

FIG. 6 is a diagram of a planar structure of a first frequency selective surface according to an embodiment of this disclosure;

FIG. 7 is a diagram of a cross-sectional structure of another antenna system according to an embodiment of this disclosure;

FIG. 8 is a diagram of a structure of a phase shifter in a feed network according to an embodiment of this disclosure;

FIG. 9 is a diagram of a cross-sectional structure of another antenna system according to an embodiment of this disclosure;

FIG. 10 is a diagram of a cross-sectional structure of another antenna system according to an embodiment of this disclosure;

FIG. 11 is a diagram of a cross-sectional structure of another antenna system according to an embodiment of this disclosure; and

FIG. 12 is a diagram of a structure of a base station according to an embodiment of this disclosure.

### DESCRIPTION OF EMBODIMENTS

To make objectives, technical solutions, and advantages of this disclosure clearer, the following further describes this disclosure in detail with reference to the accompanying drawings.

To facilitate understanding of an antenna provided in embodiments of this disclosure, the following first describes a disclosure scenario of the antenna.

The antenna provided in embodiments of this disclosure may be used in a communication device such as a base station or radar, to implement a wireless communication function.

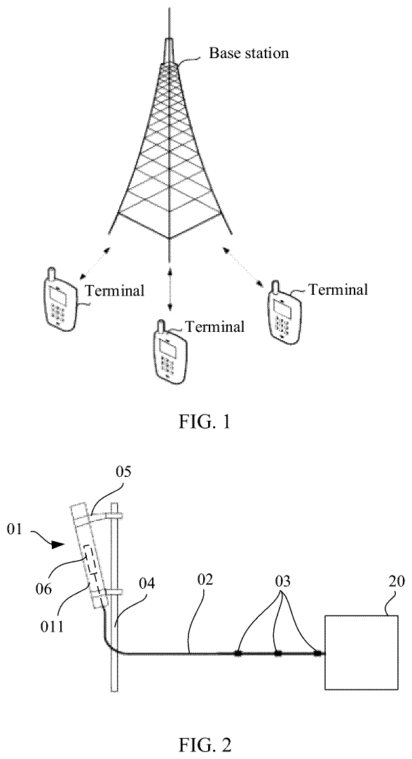

As shown in FIG. 1, the application scenario may include a base station and terminals. Wireless communication may be implemented between the base station and the terminal. The base station may be located in a base station subsystem (BBS), a UMTS terrestrial radio access network (UTRAN), or an evolved universal terrestrial radio access network (E-UTRAN), and is configured to perform cell coverage of a radio signal, to implement communication between the terminal device and a wireless network. Specifically, the base station may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a g node (gNodeB or gNB) in a new radio (NR) system, a base station in a future evolved network, or the like. This is not limited in embodiments of this disclosure.

As shown in FIG. 2, a base station provided in embodiments of this disclosure includes a base station antenna feeder system. During actual application, the base station antenna feeder system mainly includes an antenna system 01, a feed line 02, a grounding apparatus 03, and the like. The antenna system 01 is generally fastened on a pole 04. A downtilt angle of the antenna system 01 may be adjusted via an antenna adjustment bracket 05, to adjust a signal coverage range of the antenna system 01 to some extent.

In addition, the base station may further include a radio frequency processing unit 06 and a baseband processing unit 20. For example, the radio frequency processing unit 06 may be configured to: perform frequency selection, amplification, and down-conversion processing on a signal received by the antenna system 01, convert the signal into an intermediate frequency signal or a baseband signal, and send the intermediate frequency signal or the baseband signal to the baseband processing unit 20. Alternatively, the radio frequency processing unit 06 is configured to: perform up-conversion and amplification processing on an intermediate frequency signal sent by the baseband processing unit 20, convert the intermediate frequency signal into a radio signal via the antenna system 01, and send the radio signal. The baseband processing unit 20 may be connected to a feed network of the antenna system 01 via the radio frequency processing unit 06. In some implementations, the radio frequency processing unit 06 may also be referred to as a remote radio unit (RRU), and the baseband processing unit 20 may also be referred to as a baseband unit (BBU).

As shown in FIG. 2, in a possible embodiment, the radio frequency processing unit 06 may be integrated with the antenna system 01, the baseband processing unit 20 is located at a remote end of the antenna system 01, and the radio frequency processing unit 06 may be connected to the baseband processing unit 20 by using the feed line 02. In another embodiment, both of the radio frequency processing unit 06 and the baseband processing unit 20 may alternatively be located at a remote end of the antenna system 01.

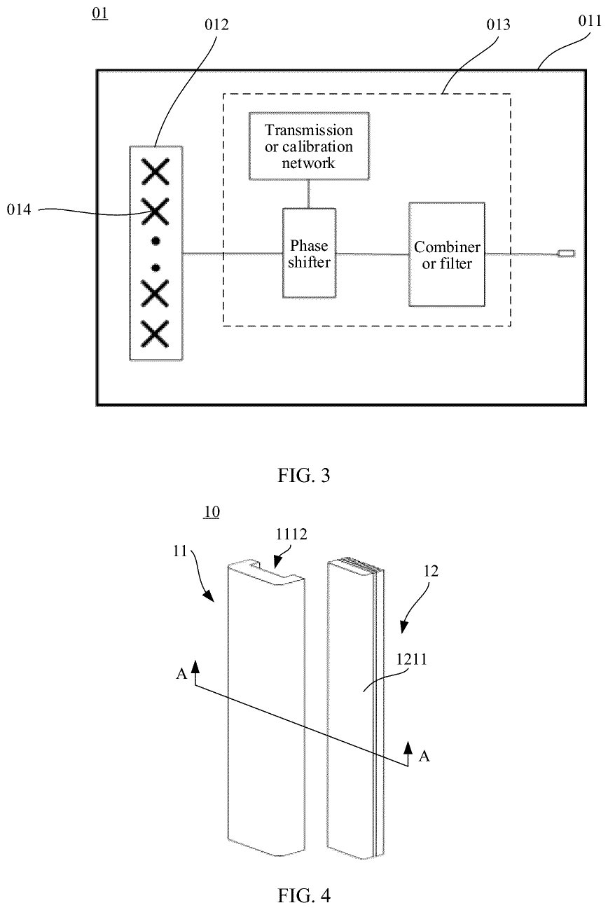

Refer to FIG. 2 and FIG. 3. The antenna system 01 used in the base station may further include a radome 011, and a reflection plate 012 and a feed network 013 that are located in the radome 011. The reflection plate 012 may also be referred to as a bottom plate. A main function of the feed network 013 is to feed a signal to a radiating assembly 014 based on a specific amplitude and phase, or send a radio signal received by a radiating assembly 014 to the baseband processing unit 20 of the base station based on a specific amplitude and phase. It may be understood that, during specific implementation, the feed network 013 may include at least one of components: a phase shifter, a combiner, a transmission or calibration network, a filter, or the like. Components and types of the feed network 013 and functions that can be implemented by the feed network 013 are not limited in this disclosure.

Certainly, the antenna system 01 may alternatively be used in a plurality of other types of communication devices. The application scenario of the antenna system 01 is not limited in this disclosure.

For the radome 011, in terms of electrical performance, the radome 011 has good electromagnetic wave penetrability, so that normal sending and receiving of electromagnetic waves between the radiating assembly 014 and the outside are not affected. In terms of mechanical performance, the radome 011 has good force-bearing performance, anti-oxidation performance, and the like, so that the radome 011 can withstand corrosion of an external harsh environment.

The radiating assembly 014 may also be referred to as an element, and is a unit that forms a basic structure of an antenna. The radiating assembly 014 can effectively emit or receive an electromagnetic wave. The radiating assembly 014 may include a plurality of elements, and the plurality of elements may form an array for use. During specific application, the elements may be classified into a single-polarization-type element, a dual-polarization-type element, and the like. During specific configuration, a type of the element may be properly selected based on actual requirements.

Refer to FIG. 2. With wide application of a 5th generation mobile communication technology (5G), a quantity of operating frequency bands of a base station antenna is increasing, and a quantity of antenna systems 01 mounted on the pole 04 is increasing. However, because a mounting position and load bearing of the pole 04 are limited, it is difficult to mount more antenna systems 01. In addition, if a quantity of poles 04 is increased, additional costs are increased for an operator. Therefore, integrating a 5G antenna system with a conventional antenna system (for example, a 4G antenna system) becomes a development trend.

Currently, a manner of integrating the 5G antenna system with the conventional antenna system mainly includes: integrating a radiating assembly of the 5G antenna system into the original 4G antenna system, and disposing two different types of radiating assemblies in a stacked manner. However, in this manner, a thickness size of the entire antenna system is significantly increased. Consequently, a frontal area of the antenna system is significantly increased, and use security of the antenna system is reduced. In addition, because different types of radiating assemblies are integrated in a same radome, the radiating assemblies can only be used at the same time and cannot be independently used or combined. Consequently, this manner has a definite limitation, and is not conducive to wide application.

Therefore, embodiments of this disclosure provide an antenna system that can effectively reduce a frontal area of the antenna system and can be flexibly used.

To make the objectives, technical solutions, and advantages of this disclosure clearer, the following further describes this disclosure in detail with reference to the accompanying drawings and specific embodiments.

Terms used in the following embodiments are merely intended to describe particular embodiments, but are not intended to limit this disclosure. Terms “one”, “a”, and “this” of singular forms used in this specification and the appended claims of this disclosure are also intended to include a form such as “one or more”, unless otherwise specified in the context clearly. It should be further understood that, in the following embodiments of this disclosure, “at least one” means one, two, or more.

Reference to “an embodiment” or the like described in this specification means that one or more embodiments of this disclosure include a particular feature, structure, or characteristic described with reference to embodiments. Therefore, statements, such as “in an embodiment”, “in some implementations”, and “in another implementation”, that appear at different places in this specification do not necessarily mean referring to a same embodiment. Instead, the statements mean referring to “one or more but not all of embodiments”, unless otherwise specifically emphasized in other ways. Terms “include”, “have”, and variants of the terms all mean “include but are not limited to”, unless otherwise specifically emphasized in other ways.

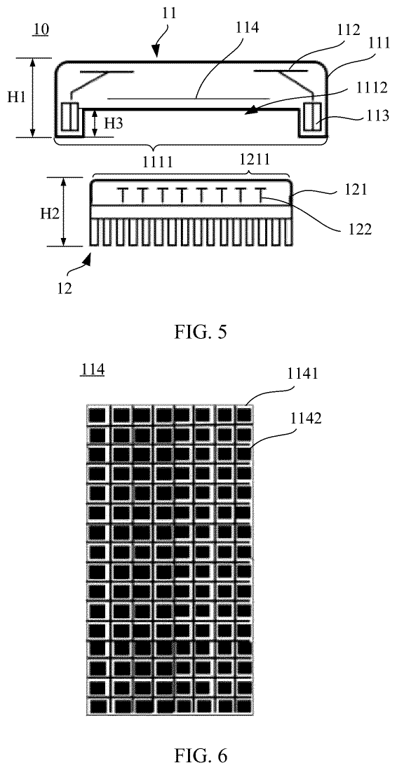

As shown in FIG. 4 and FIG. 5, in an embodiment provided in this disclosure, an antenna system 10 may include two antennas: a first antenna 11 and a second antenna 12. The first antenna 11 includes a first radome 111, a first radiating assembly 112, and a feed network 113. The second antenna 12 includes a second radome 121 and a second radiating assembly 122.

Specifically, as shown in FIG. 5, the first radome 111 has a first outer surface 1111, and the first outer surface 1111 has a groove 1112. The first radiating assembly 112 is disposed in the first radome 111, and is configured to emit or receive an electromagnetic wave. The feed network 113 is connected to the first radiating assembly 112, so that the feed network 113 feeds a signal to the first radiating assembly 112 based on a specific amplitude and phase. In addition, the feed network 113 is disposed in the first radome 111, and is located at a side part of the groove 1112. Specifically, the second radome 121 has a second outer surface 1211, the second radiating assembly 122 is disposed in the second radome 121, and the second outer surface 1211 may extend into the groove 1112. Specifically, the second outer surface 1211 is attached to a bottom wall of the groove 1112, or there is a gap between the second outer surface 1211 and a bottom wall of the groove 1112.

The antenna system 10 provided in this disclosure may include two mutually independent antennas. The two antennas may be used independently, or the two antennas may be used in combination. When the two antennas are used in combination, the second outer surface 1211 of the second antenna 12 may be attached to the bottom wall of the groove 1112 of the first antenna 11. Alternatively, even if there is a small gap, a thickness size of the combined two antennas is not significantly increased. Therefore, this helps reduce a frontal area, and improve use security. Specifically, the first radome 111 has the groove 1112, the second outer surface 1211 of the second radome 121 may extend into the groove 1112, and the second outer surface 1211 is attached to the bottom wall of the groove 1112, or there is a gap between the second outer surface 1211 and the bottom wall of the groove 1112. Therefore, after the first antenna 11 and the second antenna 12 are combined, an overall thickness is less than a sum of thicknesses of the first antenna 11 and the second antenna 12. Therefore, this helps reduce a thickness size of the entire antenna system 10. In addition, because the feed network 113 is disposed on the side part of the groove 1112, impact of the feed network 113 on the second radiating assembly 122 in the second antenna 12 is reduced. Therefore, this helps ensure normal operating performance of the second antenna 12.

Specifically, as shown in FIG. 5, in the first antenna 11, a thickness size of the first radome 111 is H1, and a depth size of the groove 1112 is H3.

In the second antenna 12, a thickness size of the second radome 121 is H2.

In the entire antenna system 10, after the first antenna 11 and the second antenna 12 are combined, a part of the second antenna 12 extends into the groove 1112. In other words, the thickness size of the antenna system 10 is H1+H2−H3, and is less than a sum of the thickness size of the first radome 111 and the thickness size of the second radome 121: H1+H2. Therefore, a structure design of the groove 1112 can effectively reduce the thickness size of the entire antenna system 10, so that the frontal area of the antenna system 10 is reduced.

In addition, as shown in FIG. 5, in this embodiment provided in this disclosure, feed networks 113 are disposed on two sides of the groove 1112. Therefore, the first radome 111 can provide plenty of mounting space for the feed network 113. In addition, because the feed networks 113 are disposed on the two sides of the groove 1112, after the second antenna 12 extends into the groove 1112, a projection of the second antenna 12 on the first outer surface 1111 does not overlap the feed network 113. Alternatively, a projection of the feed network 113 on the first outer surface 1111 is located outside the groove 1112. Therefore, a case in which the feed network 113 obstructs or blocks an electromagnetic wave emitted by the second radiating assembly 122 can be effectively avoided. This helps ensure signal sending and receiving performance of the second antenna 12.

During actual application, a radiation direction of the first antenna 11 may be approximately the same as a radiation direction of the second antenna 12.

For example, as shown in FIG. 5, in an embodiment provided in this disclosure, the radiation direction of the first antenna 11 is away from the first outer surface 1111. In other words, as shown in FIG. 5, the radiation direction of the first antenna 11 is upward. In addition, the radiation direction of the second antenna 12 faces the second outer surface 1211. In other words, as shown in FIG. 5, the radiation direction of the second antenna 12 is also upward. An electromagnetic wave generated by the second radiating assembly 122 in the second antenna 12 can be propagated through the first antenna 11.

It may be understood that, in another implementation, the radiation direction of the first antenna 11 may alternatively be different from the radiation direction of the second antenna 12. This is not limited in this disclosure.

In addition, as shown in FIG. 5, in an example provided in this disclosure, the radiation direction of the first antenna 11 is approximately the same as the radiation direction of the second antenna 12. In other words, the radiation direction of the first antenna 11 and the radiation direction of the second antenna 12 are both upward.

As shown in FIG. 5, in an embodiment provided in this disclosure, the first antenna 11 further includes a first frequency selective surface 114 (FSS). In addition, the first frequency selective surface 114 is located between the first radiating assembly 112 and the second radiating assembly 122, and is configured to reflect a signal of the first radiating assembly 112 and transmit a signal of the second radiating assembly 122. The first frequency selective surface 114 is essentially a spatial filter. When the first frequency selective surface 114 interacts with an electromagnetic wave, a definite band-pass or band-stop filtering characteristic is shown. The first frequency selective surface 114 can well reflect electromagnetic waves of some frequency bands, and can well transmit electromagnetic waves of other frequency bands.

An electromagnetic wave generated by the first radiating assembly 112 can be propagated in a direction away from the first frequency selective surface 114 based on the first frequency selective surface 114. In addition, when a part of the electromagnetic wave is propagated to the first frequency selective surface 114, the part of the electromagnetic wave can be reflected by the first frequency selective surface 114, so that propagation efficiency of the first radiating assembly 112 can be effectively improved. In addition, the electromagnetic wave generated by the second radiating assembly 122 can be effectively propagated through the first frequency selective surface 114, so that normal operating performance of the second radiating assembly 122 is not affected.

During specific application, a projection of the first radiating assembly 112 on the first frequency selective surface 114 may be completely located in the first frequency selective surface 114, so that the first frequency selective surface 114 can well reflect the electromagnetic wave generated by the first radiating assembly 112.

Certainly, in another implementation, a projection of the first radiating assembly 112 on the first frequency selective surface 114 may not be completely located in the first frequency selective surface 114. This is not specifically limited in this disclosure.

During specific application, the first frequency selective surface 114 may be of a patch type (or a medium type).

As shown in FIG. 6, in an embodiment provided in this disclosure, the first frequency selective surface 114 may include a dielectric plate 1141 and metal sheets 1142 located on the dielectric plate 1141, and a plurality of metal sheets 1142 are spaced from each other.

During specific disposition, a quantity of metal sheets 1142, a size of the metal sheet, and a spacing between metal sheets may be properly adjusted based on actual conditions. In addition, a material of the metal sheet 1142 may be copper, aluminum, or another material having good conductivity. This is not specifically limited in this disclosure.

In another implementation, the first frequency selective surface 114 may alternatively be of a groove type (or a waveguide type), or the like. A specific type of the first frequency selective surface 114 is not limited in this disclosure.

In addition, as shown in FIG. 5, during specific application, the first radiating assembly 112 may include one element, or may include two or more elements. When the first radiating assembly 112 includes a plurality of elements, the plurality of elements may be approximately located on a same plane, or the plurality of elements may be located on different planes. This is not limited in this disclosure. In addition, the first antenna 11 may be an active antenna or a passive antenna. A specific type of the first antenna 11 is not limited in this disclosure.

Correspondingly, the second radiating assembly 122 may include one element, or may include two or more elements. When the second radiating assembly 122 includes a plurality of elements, the plurality of elements may be approximately located on a same plane, or the plurality of elements may be located on different planes. This is not limited in this disclosure. In addition, the second antenna 12 may be an active antenna or a passive antenna. A specific type of the second antenna 12 is not limited in this disclosure.

An operating frequency band of the first radiating assembly 112 may be less than an operating frequency band of the second radiating assembly 122. For example, the operating frequency band of the first radiating assembly 112 may be 690 MHz to 960 MHz, and the operating frequency band of the second radiating assembly 122 may be 1710 MHz to 2180 MHz. In other words, the operating frequency band of the second radiating assembly 122 may be greater than the operating frequency band of the first radiating assembly 112. During specific application, the first frequency selective surface 114 may be of a low-frequency blocking and high-frequency passing type. For example, a frequency band used by the first frequency selective surface 114 to block (or reflect) an electromagnetic wave may include 690 MHz to 960 MHz, and a frequency band used by the first frequency selective surface 114 to transmit an electromagnetic wave may include 1710 MHz to 2180 MHz.

Certainly, during specific application, the operating frequency band of the first radiating assembly 112 may alternatively be greater than the operating frequency band of the second radiating assembly 122. In addition, the first frequency selective surface 114 may be of a high-frequency blocking and low-frequency passing type. Details are not described herein again.

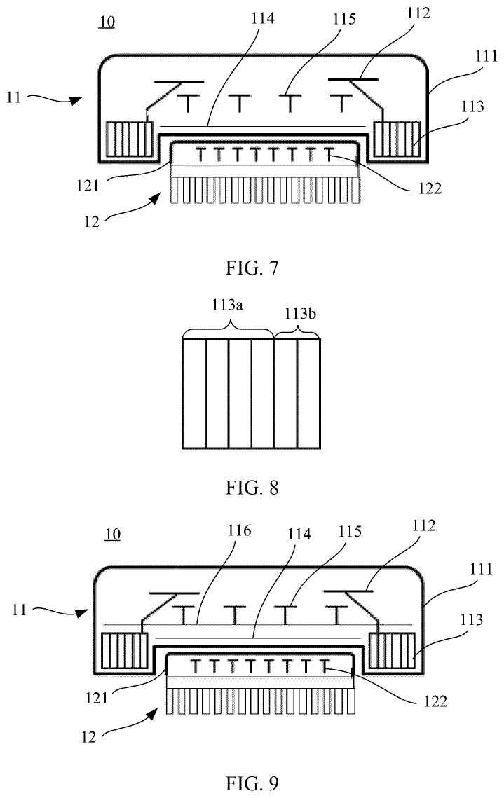

As shown in FIG. 7, in another embodiment provided in this disclosure, a first antenna 11 may further include a third radiating assembly 115. An operating frequency band of the third radiating assembly 115 may be different from an operating frequency band of the first radiating assembly 112, so that an operating frequency band range of the first antenna 11 can be effectively improved.

Refer to FIG. 7 and FIG. 8. A feed network 113 may include a plurality of phase shifters. Some phase shifters 113a may be connected to the first radiating assembly 112, and are configured to adjust a phase of the first radiating assembly 112. The remaining phase shifters 113b may be connected to the third radiating assembly 115, and are configured to adjust a phase of the third radiating assembly 115.

Certainly, during specific application, the feed network 113 may further include a combiner, a transmission or calibration network, a filter, or the like. In addition, the first radiating assembly 112 and the third radiating assembly 115 each may be connected to a corresponding component such as a combiner, a transmission or calibration network, or a filter, so that the first radiating assembly 112 and the third radiating assembly 115 each may be correspondingly adjusted.

During specific disposition, the first radiating assembly 112 and the third radiating assembly 115 may be disposed in a stacked manner, so that a width size of a first radome 111 can be effectively reduced. This helps reduce a frontal area. Certainly, in another implementation, the first radiating assembly 112 and the third radiating assembly 115 may alternatively be disposed on a same plane. This is not limited in this disclosure.

In addition, the first radiating assembly 112 and the third radiating assembly 115 may be disposed on a same side of a first frequency selective surface 114. The first frequency selective surface 114 may effectively reflect an electromagnetic wave generated by the first radiating assembly 112 and an electromagnetic wave generated by the third radiating assembly 115, so that operating performance of the first radiating assembly 112 and the third radiating assembly 115 can be effectively improved.

In addition, a projection of the third radiating assembly 115 on the first frequency selective surface 114 may be located in the first frequency selective surface 114, so that the electromagnetic wave generated by the third radiating assembly 115 can be well reflected.

Certainly, in another implementation, an additional frequency selective surface may be further disposed in a first antenna 11, to effectively reflect an electromagnetic wave generated by a third radiating assembly 115.

For example, as shown in FIG. 9, in an example provided in this disclosure, the first antenna 11 may further include a second frequency selective surface 116. The second frequency selective surface 116 is configured to reflect the electromagnetic wave of the third radiating assembly 115 and transmit an electromagnetic wave of a second radiating assembly 122.

During specific application, a projection of the third radiating assembly 115 on the second frequency selective surface 116 may be located in the second frequency selective surface 116, so that the electromagnetic wave generated by the third radiating assembly 115 can be well reflected.

In addition, in some implementations, the second frequency selective surface 116 may also well reflect an electromagnetic wave generated by a first radiating assembly 112.

Specifically, the first radiating assembly 112 and the third radiating assembly 115 may be located on a same side (an upper side in FIG. 9) of the second frequency selective surface 116. The second frequency selective surface 116 may effectively reflect the electromagnetic wave generated by the first radiating assembly 112 and an electromagnetic wave generated by the third radiating assembly 115, so that operating performance of the first radiating assembly 112 and the third radiating assembly 115 can be effectively improved.

A projection of the first radiating assembly 112 on the second frequency selective surface 116 may be located in the second frequency selective surface 116, so that the electromagnetic wave generated by the first radiating assembly 112 can be well reflected.

It may be understood that, when the first antenna 11 includes both a first frequency selective surface 114 and the second frequency selective surface 116, the first frequency selective surface 114 may be located above the second frequency selective surface 116, or the second frequency selective surface 116 may be located above the first frequency selective surface 114. This is not limited in this disclosure.

In addition, during specific application, a feed network 113 or a groove 1112 may also be disposed at various positions.

For example, as shown in FIG. 5, in an example provided in this disclosure, the groove 1112 is located in a middle part of a first outer surface 1111, and two ends of the groove 1112 penetrate edges of the first radome 111. Feed networks 113 are located on the two sides of the groove 1112.

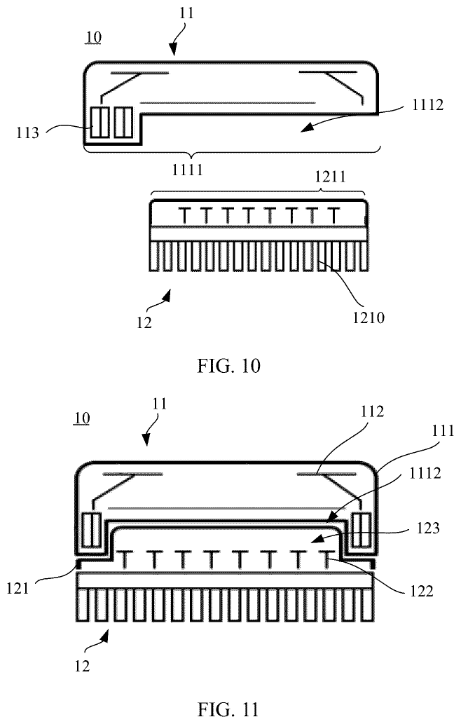

As shown in FIG. 10, in another example provided in this disclosure, a groove 1112 may be located at an edge of a first outer surface 1111, and feed networks 113 may be located on one side of the groove 1112.

A shape and disposing position of the groove 1112 are not specifically limited in this disclosure.

In addition, when a second antenna 12 is disposed, a second radome 121 may be in various shapes.

For example, as shown in FIG. 10, in an example provided in this disclosure, a second outer surface 1211 of the second radome 121 is a planar surface, and a width size of the second outer surface 1211 is not greater than a width size of the groove 1112 (a size in a left-right direction in the figure), so that the second outer surface 1211 can completely extend into the groove 1112. In addition, a heat dissipation fin 1210 may be further disposed on one side of the second radome 121, namely, a side away from the second outer surface 1211, to improve heat dissipation performance of the second antenna 12.

Alternatively, as shown in FIG. 11, in another example provided in this disclosure, a second outer surface 1211 has a protruding part 123. Specifically, an overall width of the second outer surface (not shown in the figure) may be greater than a width size of a groove 1112. A width size of the protruding part 123 is not greater than the width size of the groove 1112, so that the protruding part 123 can extend into the groove 1112.

During specific application, to avoid a case in which a feed network 113 causes adverse impact such as blocking on a second radiating assembly 122, a projection of the second radiating assembly 122 on the second outer surface may be located in the protruding part 123.

A width size of the second outer surface may be less than or equal to a width size of a first outer surface (not shown in the figure). Alternatively, a width size of the second outer surface may be greater than a width size of a first outer surface. This is not specifically limited in this disclosure.

In another implementation, a top surface of the protruding part 123 may alternatively not be disposed. After extending into the groove 1112, the protruding part 123 may be attached to a second radome 121 via a bottom wall of the groove 1112 in an airtight manner, to ensure airtightness of the second radome 121. Alternatively, it may be understood that a first radome 111 and a second radome 121 may share a part of a radome structure, to ensure airtightness of an entire antenna system 10. In addition, material usage of the radomes can be effectively reduced. This helps reduce a weight of the antenna system 10.

Alternatively, in another implementation, a bottom wall of the groove 1112 may not be disposed. After extending into the groove 1112, the protruding part 123 may be attached to a side wall of the groove 1112 in an airtight manner, to ensure airtightness of a first radome 111. Alternatively, it may be understood that a first radome 111 and a second radome 121 may share a part of a radome structure, to ensure airtightness of an entire antenna system 10. In addition, material usage of the radomes can be effectively reduced. This helps reduce a weight of the antenna system 10.

The first radome 111 may be fastened to the second radome 121 in a welding manner, a bonding manner, or the like.

Alternatively, the first radome 111 may be fastened to the second radome 121 by using an easily detached connection structure, such as a buckle or a screw, to implement a detachable connection effect. When a first antenna 11 and a second antenna 12 need to be used in combination, the first radome 111 may be conveniently fastened to the second radome 121. When the first antenna 11 and the second antenna 12 need to be used independently, the first radome 111 and the second radome 121 may be conveniently separated, so that convenience of mounting and disassembly is improved.

During specific application, the foregoing antenna system 10 may be used in a plurality of different types of communication devices, to implement a wireless communication function.

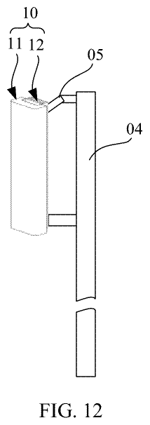

For example, as shown in FIG. 12, an example in which a communication device is a base station is used. The base station may include a pole 04 and an adjustment bracket 05. An antenna system 10 may be fastened on the pole 04 via the adjustment bracket 05.

Specifically, a structure configured to be connected to the adjustment bracket 05 may be disposed on a back part of a second radome 121. After a first radome 111 is fastened to the second radome 121, the entire antenna system 10 may be fastened on the pole via the adjustment bracket 05. Alternatively, it may be understood that a first antenna 11 may be connected to the adjustment bracket 05 via a second antenna 12.

In some implementations, a first radome 111 may alternatively be fastened to the adjustment bracket 05. Alternatively, it may be understood that a second antenna 12 may be connected to the adjustment bracket 05 via a first antenna 11.

Alternatively, both a first radome 111 and the second radome 121 may be fastened to the adjustment bracket 05. This is not limited in this disclosure.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. An antenna system, comprising a first antenna and a second antenna, wherein
the first antenna comprises:
a first radome having a first outer surface, wherein the first outer surface has a groove;
a first radiating assembly, disposed in the first radome; and
a feed network, connected to the first radiating assembly, wherein the feed network is disposed in the first radome, and the feed network is located at a side part of the groove; and
the second antenna comprises:
a second radome having a second outer surface; and
a second radiating assembly, disposed in the second radome, wherein
at least a part of the second outer surface extends into the groove.

2. The antenna system according to claim 1, wherein the first antenna further comprises a first frequency selective surface, and the first frequency selective surface is located between the first radiating assembly and the second radiating assembly, and is configured to reflect a signal of the first radiating assembly and transmit a signal of the second radiating assembly.

3. The antenna system according to claim 2, wherein a projection of the first radiating assembly on the first frequency selective surface is located in the first frequency selective surface.

4. The antenna system according to claim 1, wherein a projection of the feed network on the second radiating assembly is located outside the second radiating assembly.

5. The antenna system according to claim 2, wherein the first antenna further comprises a third radiating assembly, the third radiating assembly is connected to the feed network, and the third radiating assembly and the first radiating assembly are located on a same side of the first frequency selective surface, wherein
an operating frequency band of the first radiating assembly is different from an operating frequency band of the third radiating assembly.

6. The antenna system according to claim 5, wherein the first antenna further comprises a second frequency selective surface, the third radiating assembly and the first radiating assembly are located on a same side of the second frequency selective surface, and the second frequency selective surface is configured to reflect the signal of the first radiating assembly and a signal of the third radiating assembly and transmit the signal of the second radiating assembly.

7. The antenna system according to claim 6, wherein a projection of the third radiating assembly on the second frequency selective surface is located in the second frequency selective surface.

8. The antenna system according to claim 5, wherein a projection of the third radiating assembly on a bottom wall of the groove is located in the bottom wall.

9. The antenna system according to claim 1, wherein the operating frequency band of the first radiating assembly is less than an operating frequency band of the second radiating assembly.

10. The antenna system according to claim 5, wherein the operating frequency band of the third radiating assembly is less than an operating frequency band of the second radiating assembly.

11. The antenna system according to claim 1, wherein the second outer surface is attached to the bottom wall of the groove.

12. The antenna system according to claim 1, wherein the second outer surface has a protruding part, and the protruding part extends into the groove and is attached to the bottom wall of the groove.

13. The antenna system according to claim 12, wherein a projection of the second radiating assembly on the second outer surface is located in the protruding part.

14. The antenna system according to claim 1, wherein the first radome and the second radome are connected in a detachable manner.

15. A communication device, comprising the antenna system, wherein the antenna system comprises a first antenna and a second antenna, wherein the first antenna comprises:
a first radome having a first outer surface, wherein the first outer surface has a groove;
a first radiating assembly, disposed in the first radome; and
a feed network, connected to the first radiating assembly, wherein the feed network is disposed in the first radome, and the feed network is located at a side part of the groove; and
the second antenna comprises:
a second radome having a second outer surface; and
a second radiating assembly, disposed in the second radome, wherein
at least a part of the second outer surface extends into the groove.

16. The communication device according to claim 15, wherein the first antenna further comprises a first frequency selective surface, and the first frequency selective surface is located between the first radiating assembly and the second radiating assembly, and is configured to reflect a signal of the first radiating assembly and transmit a signal of the second radiating assembly.

17. The communication device according to claim 16, wherein a projection of the first radiating assembly on the first frequency selective surface is located in the first frequency selective surface.

18. The communication device according to claim 15, wherein a projection of the feed network on the second radiating assembly is located outside the second radiating assembly.

19. The communication device according to claim 16, wherein the first antenna further comprises a third radiating assembly, the third radiating assembly is connected to the feed network, and the third radiating assembly and the first radiating assembly are located on a same side of the first frequency selective surface, wherein
an operating frequency band of the first radiating assembly is different from an operating frequency band of the third radiating assembly.

20. The communication device according to claim 15, wherein the operating frequency band of the first radiating assembly is less than an operating frequency band of the second radiating assembly.
